(19) United States
(12) Patent Application Publication
(10) Pub. No.: US 2021/0145041 A1
(43) Pub. Date: May 20, 2021

(54) METHOD OF MANUFACTURING CHEESECAKE SANDWICHES

(71) Applicant: Lisa Ann Cotoggio, Bayside, NY (US)

(72) Inventor: Lisa Ann Cotoggio, Bayside, NY (US)

(21) Appl. No.: 17/248,496

(22) Filed: Jan. 27, 2021

Related U.S. Application Data
(63) Continuation-in-part of application No. 16/269,843, filed on Feb. 7, 2019.

(51) Int. Cl. A23P 30/10; A21D 13/38; A21D 13/32

(52) U.S. Cl. CPC A23P 30/10; A21D 13/32; A21D 13/38

(57) ABSTRACT

A method for manufacturing at least one cheesecake sandwich is provided. Specifically, a method of manufacturing at least one cheesecake sandwich while utilizing a plurality of single-sandwich mold is described. Each single-sandwich mold is preferably made of a flexible material which allows for easier ejection of the completed cheesecake sandwich from each of the single-sandwich mold.

### CLAIM OF PRIORITY

This application is a continuation-in-part of U.S. patent application Ser. No. 16/269,843 entitled “METHOD TO MAKING CHEESECAKE SANDWICHES” filed on Feb. 7, 2019, the contents of which are hereby incorporated by reference, in its entirety.

### NOTICE OF COPYRIGHTS AND TRADE DRESS

A portion of the disclosure of this patent document contains material which is subject to copyright or trade dress protection. This patent document may show and/or describe matter that is or may become trade dress of the owner. The copyright and trade dress owner has no objection to the facsimile reproduction by anyone of the patent disclosure, as it appears in the Patent and Trademark Office patent files or records, but otherwise reserves all copyright and trade dress rights whatsoever.

### FIELD OF THE EMBODIMENTS

The field of the present invention and its embodiments relate to a method of manufacturing a food item. More particularly, the present disclosure relates to a method of manufacturing cheesecake sandwiches that yields sandwiches which can be eaten easily with a single hand, and can be consumed without the need for plates or cutlery.

### BACKGROUND

While the commercial baking industry continues to grow in the United States regardless of the products consumed, not all baked goods are created equal. That is, amongst all the types of baked goods that are produced and sold, two types of baked goods stand out: cheesecakes and cookies. However, while people enjoy these foods, there is always a greater demand for higher portability, as well as for food items that can be consumed easily. Additionally, while consumers seek foods that have these traits, trends towards more healthy eating have caused consumers to desire products made of real foods, as opposed to products that use ingredients that have been synthesized in a lab or contain man-made preservatives.

While there are many types of cheesecake on the market today, all existing cheesecakes known in the art require the consumer to sit down with a plate, fork, or spoon, and in some circumstances, even with a knife, all just to enjoy this beloved, velvety dessert. Consumers are constantly in search of products filled with natural ingredients that can be eaten on the run, as the average consumer no longer has the time to sit down and eat the way they did during the previous century.

Previously, others have attempted to make a cheesecake portable by sticking it between two cookies to create a sandwich. However, merely placing a slice of cheesecake in between two cookies does not yield the desired results. When one picks such a hastily thrown together “sandwich,” several things happen: the person seeking to eat it falters when they try to maneuver the three separate components into their mouth. Their initial first bite into a sandwich with variable consistencies causes the hard cookies to break into multiple pieces as the not-so-solid center shoots out all over the place.

An object of the present invention is to provide a simple process and baking method with the use of flexible molds to create and manufacture cheesecake sandwiches at scale.

A further object of the present invention is to provide a grab-and-go cheesecake sandwich that can be eaten by a consumer without the use of plates or cutlery.

Yet another object of the present invention is to provide a process for manufacturing of a cheesecake sandwich that can be stored in a freezer for a period of six to twelve months with minimal thawing times, without the use of preservatives, while holding its taste, quality, and form for pure enjoyment at the time of consumption.

Further objects and advantages of this invention will be apparent from the following detailed description of a presently advantageous embodiment. While these articles may be suitable for the particular purpose employed, or for general use, they would not be as suitable for the purposes of the present disclosure as disclosed hereafter.

The present disclosure addresses at least one of the foregoing disadvantages. However, it is contemplated that the present disclosure may prove useful in addressing other problems and deficiencies in a number of technical areas. Therefore, the claims should not necessarily be construed as limited to addressing any of the particular problems or deficiencies discussed hereinabove. To the accomplishment of the above, this disclosure may be embodied in the form illustrated in the accompanying drawings. Attention is called to the fact, however, that the drawings are illustrative only. Variations are contemplated as being part of the disclosure.

### SUMMARY

An aspect of an example embodiment in accordance with the present disclosure is to provide a method of manufacturing at least one cheesecake sandwich. Various embodiments of this method exist. In a highly preferred embodiment, the method in accordance with the present disclosure begins by providing a first quantity of butter, a second quantity of shortening, a third quantity of a sweetening agent, a fourth quantity of eggs, a fifth quantity of vanilla extract, a sixth quantity of flour, a seventh quantity of a leavening agent, and an eighth quantity of salt. The method then proceeds to the step of combining, the first quantity, the second quantity, the third quantity, the fourth quantity, the fifth quantity, the sixth quantity, the seventh quantity, and the eighth quantity in a first vessel, and then mixing, through the use of an automatic mixer, the contents of the first vessel until a substantially homogenous mixture has formed. Preferably, the first quantity is a half cup of butter, and preferably said butter has been softened prior to being used in the method in accordance with the present disclosure. Also preferably, the second quantity is a quarter-cup of shortening, the third quantity is a cup of sugar, which is more preferably granulated cane sugar. In some embodiments, the fourth quantity is two eggs, the fifth quantity is a half-teaspoon of vanilla extract, the sixth quantity is two and one-third-cup of flour, which is more preferably an all-purpose flower. Preferably, the leavening agent is baking powder and one-tablespoon is used, while the eight quantity is a half-teaspoon of salt.

After substantial homogeny has been achieved, the mixture is removed from the first vessel, wrapped in wax paper, and then cooled to 38 degrees Fahrenheit. Preferably, this is done by placing the wrapped mixture in a refrigerator. After two hours, the wrapped mixture is removed from the fridge and is allowed to return to room temperature, when it is then unwrapped. The mixture is then rolled out into a thin sheet on a flat surface, and one or more circular dies are used to cut discs of material from this thin sheet.

A metal sheet is then covered with at least one layer of parchment paper to which the discs are disposed. The metal sheet is then placed into an oven which has been heated to the range of 340° F. to 440° F. The metal sheet is then baked for eight minutes and is then removed from the oven. The baked discs are then removed from the metal sheet and are placed on a cooling rack for ten minutes. A plurality of single-sandwich molds are then provided, which get placed on a second metal sheet. One of the baked discs get placed into each of the single-sandwich molds, which are then set aside.

The oven temperature is then lowered to the range of 300° F. to 325° F., and the cheesecake center is then prepared. To make the cheesecake, a ninth quantity of the sweetening agent, a tenth quantity of flour, an eleventh quantity of salt, a twelfth quantity of vanilla extract, a thirteenth quantity of heavy cream, a fourteenth quantity of egg yolks, a fifteenth quantity of egg whites, and a sixteenth quantity of cream cheese are all provided. The egg whites and egg yolks are preferably obtained from the same set of eggs. The method then proceeds to the egg whites being cooled to 38° F., preferably via a refrigerator. In some embodiments, a ninth quantity is one cup of granulated cane sugar, the tenth quantity is three-tablespoons of flour, the eleventh quantity is a pinch of salt, the twelfth quantity is one teaspoon of vanilla extract, the thirteenth quantity is eight ounces of heavy cream, the fourteenth quantity is four egg yolks, the fifteenth quantity is four egg whites, and the sixteenth quantity is one pound of cream cheese.

After that, the sweetening agent and the cream cheese are placed in a second vessel such as a mixing bowl and are then mixed, via an automatic mixer, into a homogenous material. Once these ingredients are fully mixed, the flour, salt, and vanilla extract are added to the second vessel, all while the mixing continues. The heavy cream is added and mixed, and then the egg yolks are added to the vessel and continuously mixed, for a period of ten minutes beyond the time of the addition of the egg yolks.

Separately, the egg whites are removed from the refrigerator and are then briskly mixed until stiff peaks of meringue are formed. Once formed, these peaks are folded into the homogenous mixture in the second vessel for three-to-five minutes. Once fully blended, the homogenous mixture is added into one or more piping bags, which are used to dispense the mixture into each of the single-sandwich molds, on top of the first baked disc that has already been inserted. One more baked disc is then inserted on top of this mixture in each of the single-sandwich molds.

These molds, while still atop the second metal sheet, are placed into the oven and allow to further bake for thirty minutes. The second metal sheet is then removed from the oven and placed onto a second cooling rack, where it is allowed to rest for sixty-to-ninety minutes. These single-sandwich molds are then transferred, one-at-a-time, and by hand into a chamber which is cooled to approximately 0° F. Preferably this chamber is a conventional freezer and the single-sandwich molds are allowed to freeze for sixteen-to-twenty-four hours, when they are subsequently removed from the cooling chamber.

The formed cheesecake sandwiches are then removed from the single-sandwich molds, and then the contents of the single-sandwich molds are deposited by placing the single-sandwich molds upside-down on a flat surface and slowly everting the single-sandwich molds, one at a time, to create a plurality of cheesecake sandwiches. Preferably the single-sandwich molds are malleable, and more preferably made of silicone. In a highly preferred embodiment, each single-sandwich mold comprises a cylinder having a top surface, a bottom surface, and a continuous wall extending therebetween. The bottom surface of the cylinder is closed and the top surface of the cylinder has an opening allowing access to the cylinder. Preferably, the top surface has a flange, and preferably this flange is square.

Embodiments of the present invention generally relate to a method of manufacturing cheesecake sandwiches that can be produced in a variety of flavors with the addition of added fillings such as fruits, chocolate chips, caramel, and nuts, to the cheesecake batter.

In the present disclosure, where a document, act, or item of knowledge is referred to or discussed, this reference or discussion is not an admission that the document, act, item of knowledge, or any combination thereof that was known at the priority date, publicly available, known to the public, part of common general knowledge or otherwise constitutes prior art under the applicable statutory provisions; or is known to be relevant to an attempt to solve any problem with which the present disclosure is concerned.

While certain aspects of conventional technologies have been discussed to facilitate the present disclosure, no technical aspects are disclaimed. It is contemplated that the claims may encompass one or more of the conventional technical aspects discussed herein.

Implementations may include one or a combination of any two or more of the aforementioned features.

These and other aspects, features, implementations, and advantages can be expressed as methods, apparatuses, systems, components, program products, business methods, and means or steps for performing functions, or some combination thereof.

Other features, aspects, implementations, and advantages will become apparent from the descriptions, the drawings, and the claims.

### BRIEF DESCRIPTION OF THE PREFERRED EMBODIMENTS

In the drawings, like elements are depicted by like reference numerals. The drawings are briefly described as follows.

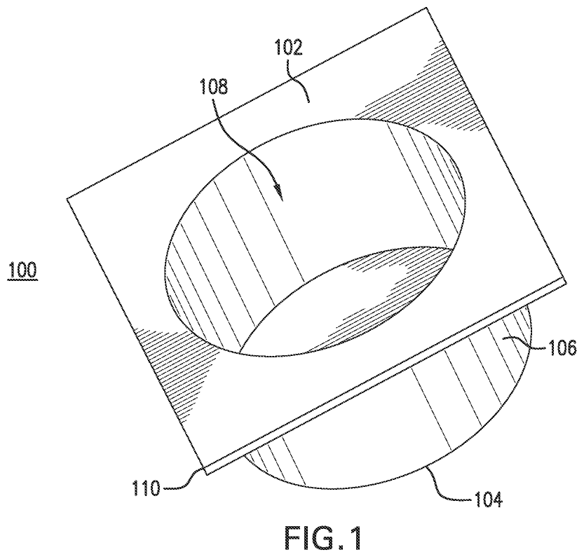

FIG. 1 is a perspective view of an embodiment of the single-sandwich mold in accordance with the present disclosure.

The present disclosure now will be described more fully hereinafter with reference to the accompanying drawings, which show various example embodiments. However, the present disclosure may be embodied in many different forms and should not be construed as limited to the example embodiments set forth herein. Rather, these example embodiments are provided so that the present disclosure is thorough, complete, and fully conveys the scope of the present disclosure to those skilled in the art. In fact, it will be apparent to those skilled in the art that various modifications and variations can be made in the present invention without departing from the scope or spirit of the invention.

### DETAILED DESCRIPTION OF THE PREFERRED EMBODIMENTS

The present disclosure teaches methods of manufacturing cheesecake sandwiches. In one embodiment, the method begins with providing the ingredients for a cookie component of the cheesecake sandwich, each with a specific quantity. These ingredients include butter, shortening, buttercream, egg yolks, whipped cream, baking soda, salt, powdered sugar, pastry flour, and bread flour. In various embodiments, these ingredients can be adapted to yield different types of cookies. For example, chocolate chips could be added.

The method then advances to adding these ingredients into a first vessel, such as a mixing bowl, and then subsequently mixing these ingredients, preferably through the use of an automatic mixer. The use of an automatic mixer allows for consistency between batches, as well as providing adequate power to create a substantially homogenized mixture of said ingredients, which is required by the method in accordance with the present disclosure.

Once these ingredients have been thoroughly mixed together, the mixture is removed from the first vessel, is wrapped in wax paper, and then is cooled to 38° F. where it remains for a period of two hours. Preferably, the mixture is cooled to this temperature by a refrigerator.

After the two hours has elapsed, the wrapped mixture is allowed to return to room temperature, upon which it is unwrapped and rolled into a thin sheet on a flat surface. One or more circular dies are then used to cut discs of material from this thin sheet, which serve as the cookies that bound the cheesecake sandwich in accordance with the present disclosure. Preferably, a die with a diameter of two inches is used. The method requires that two discs are cut for each cheesecake sandwich to be made.

The cut discs are then placed on a metal baking sheet which is lined with at least one layer of parchment paper. This sheet is then placed in an oven which has been heated to a temperature in the range of 340° F. to 440° F. and are baked for eight minutes. After that, the metal sheet is removed from the oven, the discs are removed from the metal sheet, and are placed on a cooling rack for ten minutes.

Single-sandwich molds in accordance with the present disclosure are then provided, and are placed on a second metal sheet. One baked disc is then placed into each of the single-sandwich molds, and the sheet is set aside.

The method in accordance with the present disclosure then advances to preparing the filling of said cheesecake sandwich, by first providing the ingredients for the filling. Such ingredients include sugar, cream cheese, egg yolks, salt, heavy cream, flour, egg whites, and vanilla. Preferably, the egg yolks and the eggs whites are obtained from the same egg to prevent waste. In a preferred embodiment, the eggs whites are placed in a refrigerator set to 38° F. until they are used later in the method.

A second vessel, such as a mixing bowl is then provided, and an automatic mixer is positioned to stir any contents of said vessel. The automatic mixer is then turned on, and the cream cheese and sugar are added to the second vessel and mixed into a homogenous mixture. While the automatic mixer is still running, the flour, salt, and vanilla are added to the vessel until the mixture achieves a smooth and creamy consistency. Then, the heavy cream is added to the vessel and stirred, ensuring that no bits of cream cheese are stuck to the bottom of the vessel. The egg yolks are then added to the vessel until the mixture thickens, which will take roughly ten minutes.

At this point in the method, the egg whites are removed from the refrigerator and are vigorously mixed until the egg whites form stiff peaks of meringue, and do not move when shaken, which takes roughly eight-to-fifteen minutes. Other flavors can be added in such as milk chocolate, chocolate chips, amaretto paste, and/or fillings such as fruits, caramel, and nuts to create a variety of cheesecake sandwich choices. This meringue is then folded into the mixture in the second vessel until the mixture achieves an airy consistency, which will take roughly three-to-five minutes to achieve.

The mixture is then removed from the vessel and placed into one or more piping bags, which are used to deposit a portion of the mixture into each of the single-sandwich molds, atop the disk that was already placed within each of said molds. A second baked disk is then placed on top of the mixture within each single-sandwich mold. The second metal sheet is then transferred to an oven heated to a temperature in the range of 300° F. to 325° F. and is baked for approximately thirty minutes.

The second metal sheet is then removed from the oven and is set to cool for sixty-to-ninety minutes. After the cooling period is finished, each of the single-sandwich molds is carefully transferred, by a human using two hands, to a dry baking pan. Once all of the single-sandwich molds are placed on the dry baking pan, they are placed in a freezer or other cooling device at a temperature of approximately 0° F. The dry baking pan is then removed from the freezer or other cooling device after a period of sixteen-to-twenty-four hours.

The cheesecake sandwiches within each of the single-sandwich molds are then carefully removed from each mold by peeling away the mold from the frozen cheesecake sandwich. The fact that the cheesecake sandwich is frozen is beneficial as it minimizes damage to the cheesecake sandwich while being removed. The cheesecake sandwiches in accordance with the present disclosure can be frozen for six-to-twelve months, thawed, and then consumed. The cheesecake sandwiches in accordance with the present disclosure can also be refrigerated up to seven-to-ten days and consumed or eaten immediately without the use of unnatural ingredients or preservatives.

FIG. 1 is a perspective view of an embodiment of the single-sandwich mold in accordance with the present disclosure. This embodiment of the single-sandwich mold 100 is comprised of a cylinder having a top surface 102, a bottom surface 104, and a continuous wall 106 that extends therebetween. The top surface has an opening 108 that is equal in size to the diameter of the cylinder, and is equipped with a square flange 110. The bottom surface caps off the cylinder.

Preferably, the single-sandwich mold 100 will be constructed out of a flexible and malleable material, so that it can be separated from the cheesecake sandwich in accordance with the present disclosure without damaging said cheesecake. In a highly preferred embodiment, this flexible and malleable material is silicone, as it is relatively inexpensive, widely available, and a highly durable material.

It is understood that when an element is referred hereinabove as being “on” another element, it can be directly on the other element or intervening elements may be present therebetween. In contrast, when an element is referred to as being “directly on” another element, there are no intervening elements present.

Moreover, any components or materials can be formed from a same, structurally continuous piece or separately fabricated and connected.

It is further understood that, although ordinal terms, such as, “first,” “second,” and “third,” are used herein to describe various elements, components, regions, layers and/or sections, these elements, components, regions, layers and/or sections should not be limited by these terms. These terms are only used to distinguish one element, component, region, layer and/or section from another element, component, region, layer and/or section. Thus, a “first element,” “component,” “region,” “layer” and/or “section” discussed below could be termed a second element, component, region, layer and/or section without departing from the teachings herein.

Features illustrated or described as part of one embodiment can be used with another embodiment and such variations come within the scope of the appended claims and their equivalents.

Spatially relative terms, such as “beneath,” “below,” “lower,” “above,” “upper” and the like, are used herein for ease of description to describe one element or feature's relationship to another element(s) or feature(s) as illustrated in the figures. It is understood that the spatially relative terms are intended to encompass different orientations of the device in use or operation in addition to the orientation depicted in the figures. For example, if the device in the figures is turned over, elements described as “below,” or “beneath” other elements or features would then be oriented “above” the other elements or features. Thus, the example term “below” can encompass both an orientation of above and below. The device can be otherwise oriented (rotated 90 degrees or at other orientations) and the spatially relative descriptors used herein interpreted accordingly.

Example embodiments are described herein with reference to cross section illustrations that are schematic illustrations of idealized embodiments. As such, variations from the shapes of the illustrations, for example, of manufacturing techniques and/or tolerances, are to be expected. Thus, example embodiments described herein should not be construed as limited to the particular shapes of regions as illustrated herein, but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As the invention has been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose the invention, including the best mode, and also to enable any person skilled in the art to practice the invention, including making and using any devices or systems and performing any incorporated methods. The patentable scope of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

In conclusion, herein is presented a method of manufacturing cheesecake sandwiches. The disclosure is illustrated by example in the drawing figures, and throughout the written description. It should be understood that numerous variations are possible while adhering to the inventive concept. Such variations are contemplated as being a part of the present disclosure.

What is claimed is:

1. A method of manufacturing at least one cheesecake sandwich, comprising the steps of:
i. providing a first quantity of butter, a second quantity of shortening, a third quantity of a sweetening agent, a fourth quantity of eggs, a fifth quantity of vanilla extract, a sixth quantity of flour, a seventh quantity of a leavening agent, and an eighth quantity of salt;
ii. combining, the first quantity, the second quantity, the third quantity, the fourth quantity, the fifth quantity, the sixth quantity, the seventh quantity, the eighth quantity in a first vessel;
iii. mixing, through the use of an automatic mixer, the contents of the first vessel until a substantially homogenous mixture has formed;
iv. removing the substantially homogenous mixture from the first vessel;
v. wrapping the substantially homogenous mixture into wax paper;
vi. cooling the wrapped substantially homogeneous mixture to 38° F. for a period of two hours;
vii. allowing the wrapped substantially homogenous mixture to return to room temperature;
viii. unwrapping the wrapped substantially homogenous mixture;
ix. rolling the mixture on a flat surface to create a thin sheet;
x. cutting a plurality of discs from the thin sheet, through the use of a circular die;
xi. placing the plurality of disks on a first metal sheet covered with at least one layer of parchment paper;
xii. heating an oven to a temperature in the range of 340° F. to 440° F.;
xiii. placing the first metal sheet in the oven for eight minutes;
xiv. removing the first metal sheet from the oven;
xv. removing the plurality of disks from the metal sheet and placing said disks on a cooling rack for ten minutes;
xvi. providing, a plurality of single-sandwich molds;
xvii. placing the plurality of single-sandwich molds on a second metal sheet;
xviii. placing one of the plurality of disks in each of the single-sandwich molds on the second metal sheet;
xix. lowering the temperature of the oven to the range of 300° F. to 325° F.;
xx. providing a ninth quantity of the sweetening agent, a tenth quantity of flour, an eleventh quantity of salt, a twelfth quantity of vanilla extract, a thirteenth quantity of heavy cream, a fourteenth quantity of egg yolks, a fifteenth quantity of egg whites, and a sixteenth quantity of cream cheese;
xxi. cooling the fifteenth quantity to 38° F.;
xxii. placing the sixteenth quantity and the ninth quantity in a second vessel;
xxiii. mixing, through the use of the automatic mixer, the sixteenth quantity and the ninth quantity into a homogeneous material;
xxiv. adding, the tenth quantity, the eleventh quantity, and the twelfth quantity into the homogenous material by mixing, through the continued use of the automatic mixer;
xxv. adding, the thirteenth quantity into the homogenous materials by mixing, through the continued use of the automatic mixer;
xxvi. adding, the fourteenth quantity to the homogeneous mixture and continue to mix, through the continued use of the automatic mixer, for ten minutes;
xxvii. mixing the fifteenth quantity for eight-to-fifteen minutes or until stiff peaks of meringue are formed;
xxviii. folding the stiff peaks of meringue into the homogenous mixture for three-to-five minutes;
xxix. placing the homogenous mixture into a piping bag;
xxx. dispensing, via the piping bag, a portion of the homogenous mixture into each of the single-sandwich molds on the second metal sheet;
xxxi. placing another of the plurality of disks into each of the single-sandwich molds on the second metal sheet;
xxxii. placing the second metal sheet into the oven;
xxxiii. allowing the second metal sheet to rest in the oven for thirty minutes;
xxxiv. removing the second metal sheet from the oven and placing the second metal sheet onto a cooling rack;
xxxv. allowing the second metal sheet to rest on the cooling rack for sixty-to-ninety minutes;
xxxvi. individually transferring each of the single-sandwich molds on the second metal sheet, by hand, into a chamber cooled to approximately 0° F.;
xxxvii. allowing the single-sandwich molds from the previous step to rest for sixteen-to-twenty-four hours;
xxxviii. removing the single-sandwich molds from the chamber;
xxxix. depositing the contents of the single-sandwich molds by placing the single-sandwich molds upside-down on a flat surface and slowly everting the single-sandwich molds to create a plurality of cheesecake sandwiches.

2. The method of claim 1, wherein the sweetening agent is cane sugar.

3. The method of claim 2, wherein the leavening agent is baking powder.

4. The method of claim 3, wherein the single-sandwich mold is malleable.

5. The method of claim 4, wherein the single-sandwich mold is constructed out of silicone.

6. The method of claim 5, wherein the single-sandwich mold comprises:
a cylinder having a top surface, a bottom surface, and a continuous wall extending therebetween,
wherein the top surface is equipped with a flange.

7. The method of claim 6, wherein the flange is square.
